(19) United States
(12) Patent Application Publication
(10) Pub. No.: US 2019/0321664 A1
(43) Pub. Date: Oct. 24, 2019

(54) Mounting Type High-Altitude Movement Fall Arrester

(71) Applicant: Shu-Chen Hsu, Township (TW)

(72) Inventor: Shu-Chen Hsu, Township (TW)

(21) Appl. No.: 15/955,710

(22) Filed: Apr. 18, 2018

(51) Int. Cl. A62B 35/00

(52) U.S. Cl. CPC A62B 35/0068; F16B 2/12

(57) ABSTRACT

A mounting type high-altitude movement fall arrester includes an axle; two capturing bases, two locking members and two springs. The axle includes right and left sections with ratchets and configured to limiting the capturing bases. The capturing base includes a hook portion and a beam. The beam includes a fastening portion and a supporting portion, providing a cavity for receiving the locking member therein. The cavity includes a second slot to limit the fastening portion. The locking member includes a locking teeth portion to engage with the ratchets. The supporting portion is for spring installation and provides a pre-stress on the locking member; thereby, the locking member uses a location of the second slot as a supporting point for the locking teeth portion to engage with the ratchets; and when the pre-stress is overcome, the locking member drives the locking teeth portion to disengage from the ratchets.

### (a) TECHNICAL FIELD OF THE INVENTION

The present invention is related to a high-altitude movement fall arrest having a lock mounted onto a capturing base without any pivotal axles exposed at the outer of the lock and the capturing base.

### (b) DESCRIPTION OF THE PRIOR ART

It is known that prior arts, such US20070163834A1 “Slidable Beam Anchor” and U.S. Pat. No. 8,646,575B1 “Beam Anchor” disclose fall arrestors; however, the prior arts of these two patents are found to have the following drawbacks. For example, in the U.S. Pat. No. 8,646,575B1 patent, the locking member (28), the spring (30) and the beam (W) of the capturing base (29) are formed of circular holes thereon matching with each other in order to allow to pivotal axle (34) to penetrate therethrough. Nevertheless, such technique is found to have the following drawbacks:

1. The pivotal axle (34) is configured to expose outward, but since there are great amount of foreign objects at construction site with severe dusty environment, the pivotal axle (34) is very likely to collide with foreign objects, leading to deformation thereof. In addition, the likelihood of intrusion of dust into the circular holes of the locking member (28), spring (30) or beam (W) is high, leading to jamming and extra efforts in the operation of the locking member (28).

2. The locking member (28) utilizes the circular hole for maintaining the pivotal axle (34) therein; therefore, when the locking member (28) collides with the foreign object, the circular hole can be deformed, causing interference with the pivotal axle (34).

3. The pivotal axle (34) is exposed at the outer side of the locking member (28); therefore, such appearance is known and is devoid of novelty.

### SUMMARY OF THE INVENTION

The present invention provides a mounting type high-altitude movement fall arrester, and the main technical feature thereof relies in the modified capturing base, locking member and spring in such a way that the capturing base includes a fastening portion and a supporting portion arranged on the beam. In addition, the locking member includes a cavity for receiving the fastening portion and the supporting portion. The cavity further includes a second slot provided to limit the fastening portion. The locking member further includes a locking teeth portion extended from a bottom end thereof and configured to engage with the ratchet of the axle. The supporting portion is provided for a spring to be wrapped thereon in order to allow the spring to be received inside the cavity. Furthermore, a pre-stress is exerted onto the locking member in order to allow the locking member to use the location where the second slot abuts against the fastening portion as a supporting point in such a way that the locking teeth portion can be maintained to engage with the ratchet, or in such a way that when the pre-stress is overcome, the locking member is able to drive to locking teeth portion to disengage from the ratchet.

Accordingly, the locking member can be mounted onto the capturing base in order to allow the locking member to have a greater anti-collision and shock-absorbing capability. In addition, the mounting type high-altitude movement fall arrester of the present invention is able to overcome the drawback of exposed pivotal axle associated with the prior arts.

### BRIEF DESCRIPTION OF THE DRAWINGS

FIG. 1 is a perspective assembly view of the present invention;

FIG. 2 is a partial exploded view of the present invention;

FIG. 3 is a perspective view of the locking member of the present invention;

FIG. 4 is an exploded view of the capturing base and the locking member of the present invention;

FIG. 5 is a schematic view of the locking teeth portion engaged with the ratchet of the present invention;

FIG. 6 is a schematic view showing the pressing of the locking teeth portion of the locking member in order to disengage from the ratchet; and

FIG. 7 is a schematic view showing an implementation example of the retention structure of the present invention.

### DETAILED DESCRIPTION OF THE PREFERRED EMBODIMENTS

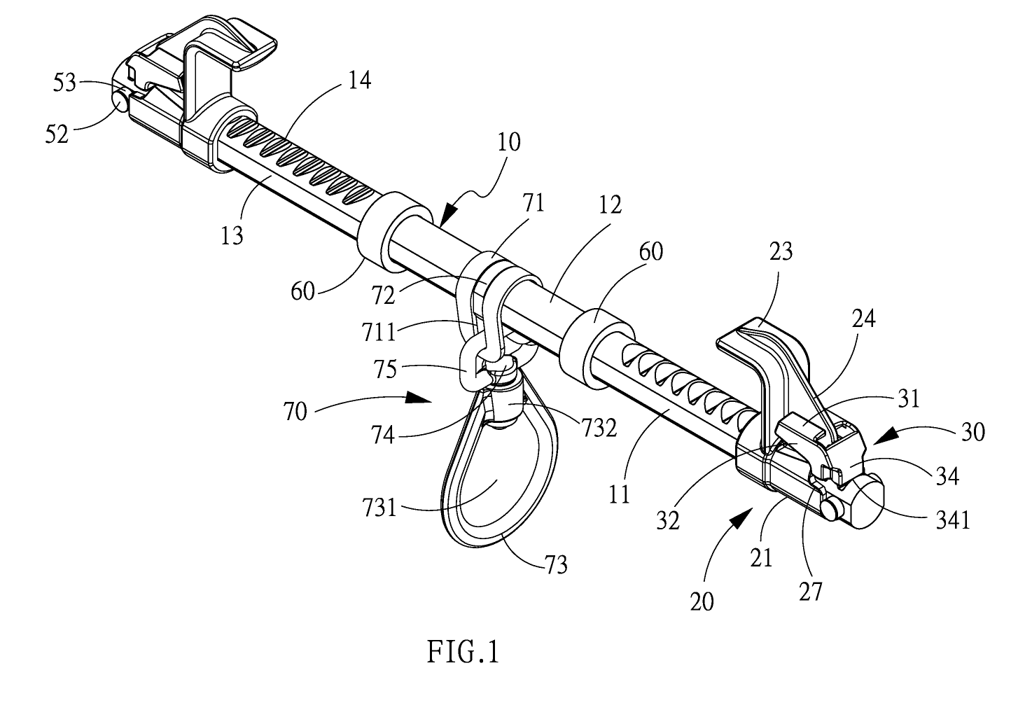

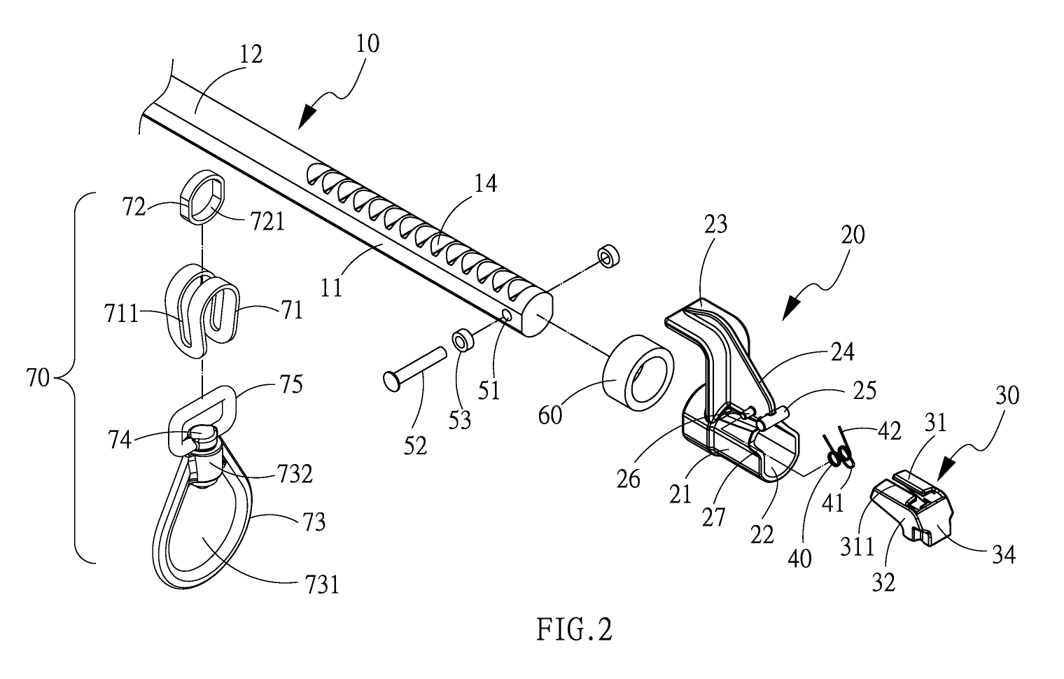

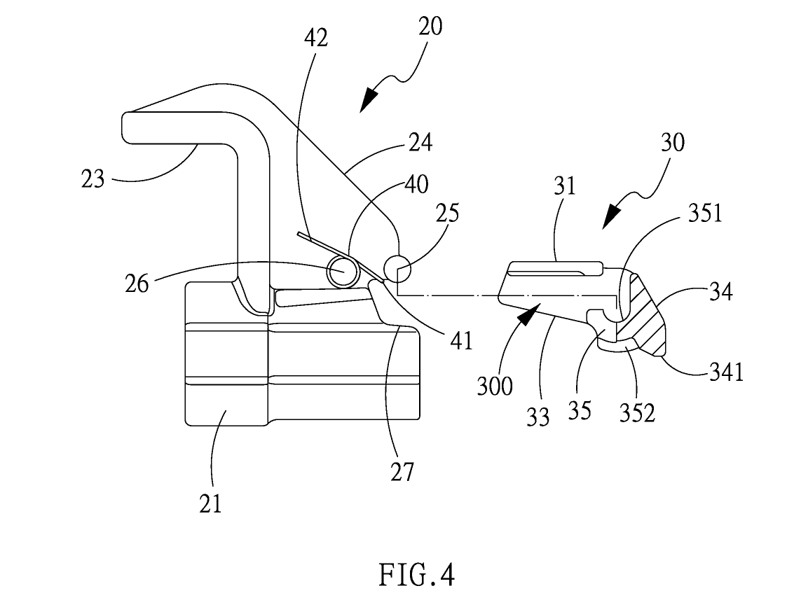

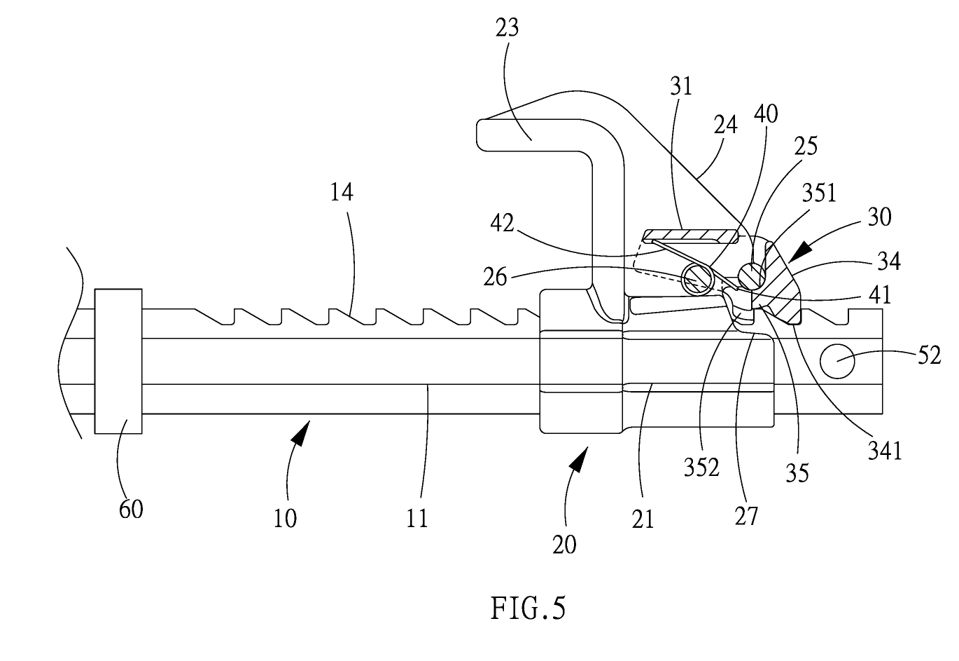

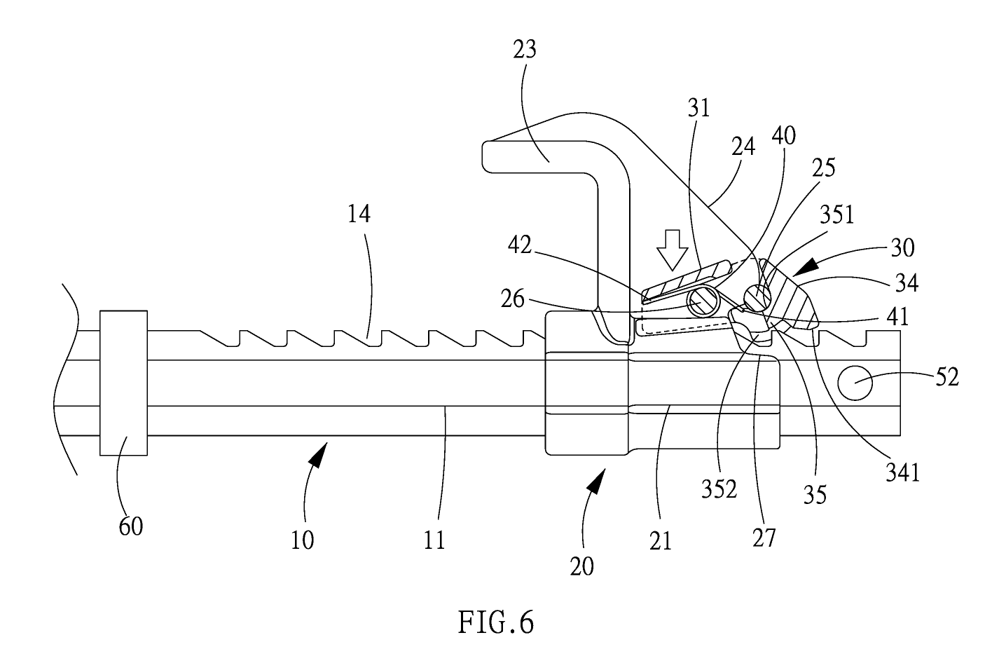

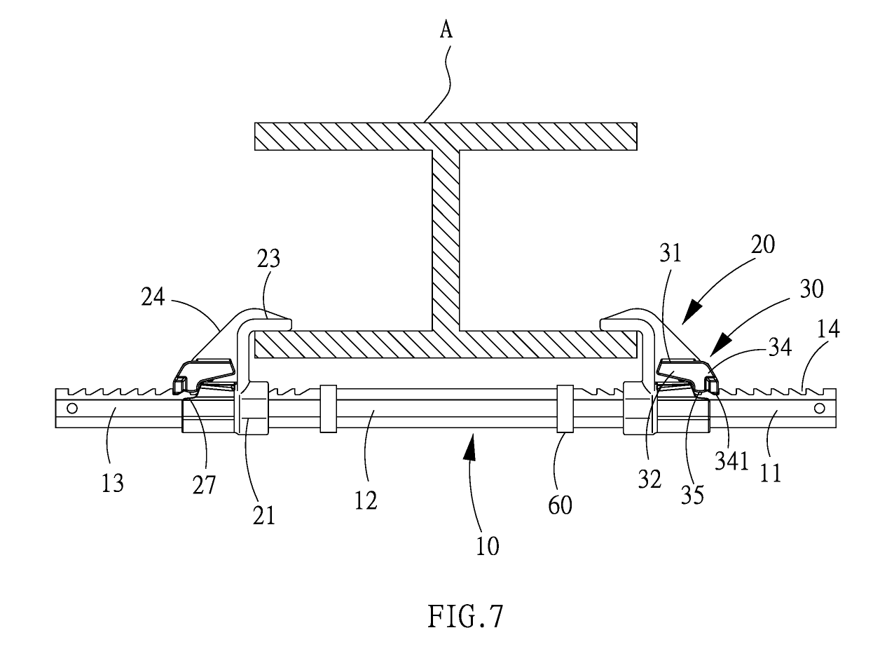

Please refer to FIG. 1 to FIG. 7. The present invention provides a mounting type high-altitude movement fall arrester comprising the following.

An axle 10 is arranged to have a non-circular cross section and includes a right section 11, a middle section 12 and a left section 13 formed thereon sequentially along the axial direction. In addition, the top edges of the right section 11 and the left section 13 include one-way ratchets 14 formed along the axial direction and arranged spaced apart from each other in opposite directions.

Two capturing bases 20 include a bottom portion with a pipe 21 arranged thereon respectively. The pipe 21 includes a first hole 22 formed along an axial direction thereof. The shape of the first hole 22 matches with the cross section of the axle 10 in order to allow the two capturing bases to correspondingly slide along the right section 11 and the left section 13 axially without rotating about the axle 10 on their own. The top portions of the two capturing base 20 further include a hook portion 23 of Type H steel structure respectively and capable of clamping toward each other. In addition, the rear side of the hook portion 23 and the center of the top of the pipe 21 include a beam 24 arranged therebetween. The front and rear sides of the beam 24 include a fastening portion 25 and a supporting portion 26 having a circular rod shape and symmetrically protruded therefrom respectively in order to allow the supporting portion 26 to be positioned between the fastening portion 25 and the hook portion 23. Furthermore, the pipe 21 includes a notch 27 formed underneath the fastening portion 26 and connected to the first hole 22.

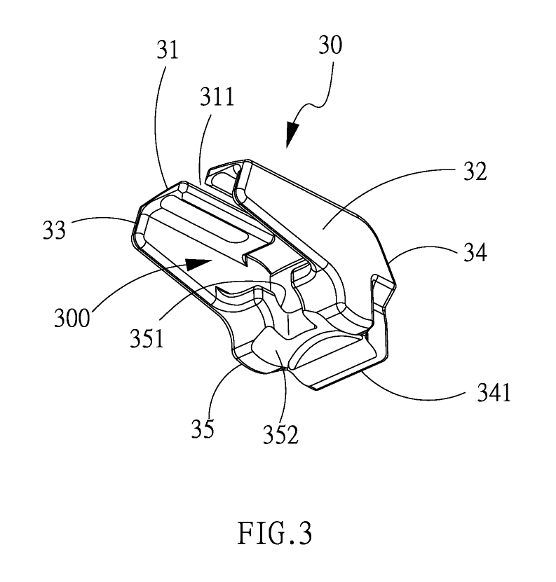

Two locking member 30 are correspondingly installed onto the two capturing bases 20. Please refer to FIGS. 3, 4, 5 and 6. The locking member 30 is a hollow bracket formed circumferentially by a top plate 31, a front plate 32, a rear plate 33 and an end portion 34. In addition, a base portion 35 is formed among the front plate 32, the rear plate 33 and the bottom end of the end portion 34 in order to allow the locking member 30 to define a cavity 300 connected to both the internal and external thereof. The top plate 31 includes a first slot 311 formed thereon and configured to be inserted onto the beam 24 correspondingly in order to allow the fastening portion 25 and the supporting portion 26 to be received inside the cavity 35. The base portion 35 can be inserted into the notch 27. At the same time, the fastening portion 25 is located on top of the base portion 35, and the base portion 35 includes a second slot 351 formed to indent inward at the internal of the cavity 300 and configured to limit the fastening portion 25. Furthermore, the bottom end of the base portion 35 further includes a third slot 352 having an arched shape or a V shape and formed to indent upward. The third slot 352 is able to match with the top edge of the axle 10 and is configured to allow the base portion 35 of the locking member 30 to be stably arranged on the locking member 10 without any wobbling forward and backward. The bottom end of the end portion 34 includes a locking teeth portion 341 extended downward and configured to engage with the ratchets 14.

Two springs 40 are wrapped and positioned onto the supporting portions 26 of the two capturing bases 20 correspondingly. The spring 40 includes a first leg 41 extended therefrom and having an arched shape. The first leg 41 is hooked onto the bottom end of the beam 24. The spring 40 further includes a second leg 42 extended therefrom, and the second leg 42 abuts against the top plate 31 in order to allow the spring 40 to be received inside the cavity 300. In addition, a pre-stress is exerted onto the locking member 30 in order to allow the locking member 30 to use the location where the second slot 351 abutted against the fastening portion 25 to be a supporting portion in such a way to allow the locking teeth portion 341 to maintain to engage with the rackets 14. However, when a user presses the top plate 31 or forces the capturing base 20 to move toward the direction of the middle section 12 to overcome the pre-stress, the locking member 30 is able to use the location where the second slot 351 abutted against the fastening portion 25 to be a supporting point to wobble in an opposite direction in order allow the locking teeth portion 341 to disengage from the ratchets; thereby, the two capturing bases 20 are able to slide axially along the right section 11 and the left section 13 correspondingly in order to further operate the hook portion 23 to whether retain the Type H structure A. It shall be noted that a distance between the location of the top plate withstanding the pre-stress and the fastening portion 25 is relatively greater than a distance between the fastening portion 25 and the locking teeth portion 341. Therefore, the leverage effect can be used to allow the locking teeth portion 341 to engage with the ratchets 14 properly without any hazards of loose engagement therebetween.

A first blocking structure is arranged on two left and right ends of the axle 10 and includes a second hole 51 penetrating therethrough radially. The second hole 51 is provided for a blocking bolt 52 to be installed thereon. In addition, two wends of the blocking bolts 52 include rubber buffers 53 arranged thereon respectively in order to allow the buffers 53 to restrict the pipe 21 of the corresponding capturing base 20 such that the two capturing bases 20 cannot disengage from the axle 10.

A second blocking structure is arranged on two left and right ends of the middle section 12 of the axle 10 and includes a blocking ring 60 secured thereon respectively, which is used for restricting the two capturing bases 20 from entering into the middle section 12.

In addition, a mounting structure 70 is formed by a belt 71, an intermediate sleeve 72, a first mounting ring 73, a vertical shaft 74 and a second mounting ring 72. The belt 71 is of an inverted U shape for wrapping onto the middle section 12 of the axle 10 and includes a fourth slot 711 penetrating therethrough along a long axis direction thereof in order to reduce the contact area of the belt during the movement along the middle section 12. The intermediate sleeve 72 includes a third hole 721 capable sliding along the middle section 12 axially. The intermediate sleeve 72 is restricted inside the fourth slot 711 in order to overcome the winding issue of the belt 71 during the movement along the middle section 12. The first mounting ring 73 includes a circular hole 731 having its circumference sealed, and the circular hole 731 is provided to hook onto the harness worn by a user. In addition, the top edge of the first mounting ring 73 includes a connecting base 732, and the connecting base 732 is provided for the vertical shaft 74 to be pivotally attached thereto. The vertical shaft 74 further includes a second mounting ring 75 arranged on top of the connecting base 732, and the second mounting ring 75 is installed onto the fourth slot 711 of the belt 71. Accordingly, the harness worn by the user is able to function cooperatively with the first mounting ring 73, the vertical shaft 74 and the second mounting ring 75 such that cable tangling and jamming can be prevented.

According to the aforementioned structure of the present invention, it can be understood that the mounting type high-altitude movement fall arrester of the present invention has at least the following characteristics:

1. The fastening portion 25 and the supporting portion 26 of the present invention are concealed inside the cavity 300 of the locking member 30; therefore, it is able to reduce dust from attaching onto the fastening portion 25 and the supporting portion 26. In addition, it is able to prevent the deformation of the fastening portion 25 and the supporting portion 26 due to collision with foreign objects. Consequently, the operation of the locking member 30 can be maintained smoothly without jamming.

2. The second slot 351 and the locking teeth portion 341 of the locking member 30 of the present invention use the pre-stress of the spring 40 for mounting onto the fastening portion 25 and the ratchets 14. As a result, the locking member 30 is able to have a greater anti-collision capability.

3. The present invention is able to overcome the drawback of exposed pivotal axle of locking member associated with the prior arts; therefore, the present invention has a unique and novel appearance.

I claim:

1. A mounting type high-altitude movement fall arrester, comprising:
an axle; two capturing bases, two locking members and two springs;
wherein, the axle includes a right section and a left section formed with ratchets thereon respectively, the right and left sections are configured to slidably limiting the capturing bases thereon respectively; the capturing base includes a hook portion and a beam;
the beam includes a fastening portion and a supporting portion; the fastening portion and the supporting portion are formed of a cavity for receiving the locking member therein, and the cavity further includes a second slot formed therein and configured to limit the fastening portion; the locking member further includes a locking teeth portion extended from a bottom end thereof and configured to engage with the ratchets;
wherein the supporting portion is configured for the spring to install thereon in order to allow the spring to be received inside the cavity and to provide a pre-stress exerted onto the locking member in such a way that the locking member uses a location where the second slot abuts against the fastening portion as a supporting point in order to allow the locking teeth portion to engage with the ratchets; and in such a way that when the pre-stress is overcome, the locking member is able to drive the locking teeth portion to disengage from the ratchets.

2. The mounting type high-altitude movement fall arrester according to claim 1, wherein a distance between a location where the locking member withstands the pre-stress of the spring to the fastening portion is greater than a distance between the fastening portion and the locking teeth portion.

3. The mounting type high-altitude movement fall arrester according to claim 1, wherein the fastening portion and the supporting portion are of a rod shape protruding at front and rear of the beam in order to allow the supporting portion to be positioned between the fastening portion and the hook portion; the locking member is a hollow bracket formed by a top plate, a front plate, a rear plate and an end portion; the locking portion further includes a base portion arranged between the front plate, the rear plate and the bottom end of the end portion in order to define a cavity connected to an external thereof;
the top plate includes a first slot provided for the beam to be inserted therein, and the base portion includes a second slot indented inward at an internal of the cavity; the locking teeth portion is arranged to extend downward from the bottom end of the end portion.

4. The mounting type high-altitude movement fall arrester according to claim 2, wherein the fastening portion and the supporting portion are of a rod shape protruding at front and rear of the beam in order to allow the supporting portion to be positioned between the fastening portion and the hook portion; the locking member is a hollow bracket formed by a top plate, a front plate, a rear plate and an end portion; the locking portion further includes a base portion arranged between the front plate, the rear plate and the bottom end of the end portion in order to define a cavity connected to an external thereof;
the top plate includes a first slot provided for the beam to be inserted therein, and the base portion includes a second slot indented inward at an internal of the cavity; the locking teeth portion is arranged to extend downward from the bottom end of the end portion.

5. The mounting type high-altitude movement fall arrester according to claim 3, wherein the spring includes a first leg of an arched shape extended therefrom, and the first leg is positioned on a bottom end of the beam; the spring further includes a second leg extended therefrom, and the second leg abuts against the top plate in order to provide a pre-stress exerted onto the locking member.

6. The mounting type high-altitude movement fall arrester according to claim 4, wherein the spring includes a first leg of an arched shape extended therefrom, and the first leg is positioned on a bottom end of the beam; the spring further includes a second leg extended therefrom, and the second leg abuts against the top plate in order to provide a pre-stress exerted onto the locking member.

7. The mounting type high-altitude movement fall arrester according to claim 3, wherein the axle is of a non-circular cross section, and the capturing base includes a pipe at a bottom portion thereof; the pipe includes a first hole formed thereon, and the first hole is of a shape matching with the cross section of the axle in order to allow the capturing base to slide along the right section and the left section;
the hook portion is formed on top of the pipe, and the beam is connected between the pipe and the hook portion.

8. The mounting type high-altitude movement fall arrester according to claim 4, wherein the axle is of a non-circular cross section, and the capturing base includes a pipe at a bottom portion thereof; the pipe includes a first hole formed thereon, and the first hole is of a shape matching with the cross section of the axle in order to allow the capturing base to slide along the right section and the left section;
the hook portion is formed on top of the pipe, and the beam is connected between the pipe and the hook portion.

9. The mounting type high-altitude movement fall arrester according to claim 7, wherein the pipe includes a notch formed underneath the fastening portion and connected to the first hole; the notch is provided for the base portion to be inserted therein.

10. The mounting type high-altitude movement fall arrester according to claim 8, wherein the pipe includes a notch formed underneath the fastening portion and connected to the first hole; the notch is provided for the base portion to be inserted therein.

11. The mounting type high-altitude movement fall arrester according to claim 3, wherein the axle includes two left and right ends having a second formed to penetrate therethrough radially; the second hole is provided for a blocking bolt to be inserted therein; the blocking bolt includes two end edges having a rubber buffer arranged thereon respectively in order to allow the buffer to limit the corresponding capturing base from disengaging from the axle.

12. The mounting type high-altitude movement fall arrester according to claim 4, wherein the axle includes two left and right ends having a second formed to penetrate therethrough radially; the second hole is provided for a blocking bolt to be inserted therein; the blocking bolt includes two end edges having a rubber buffer arranged thereon respectively in order to allow the buffer to limit the corresponding capturing base from disengaging from the axle.

13. The mounting type high-altitude movement fall arrester according to claim 3, wherein the axle further includes a middle section arranged between the right section and the left section, and a blocking ring secured at two left and right ends of the middle section and configured to limit the two capturing bases from entering into the middle section.

14. The mounting type high-altitude movement fall arrester according to claim 4, wherein the axle further includes a middle section arranged between the right section and the left section, and a blocking ring secured at two left and right ends of the middle section and configured to limit the two capturing bases from entering into the middle section.

15. The mounting type high-altitude movement fall arrester according to claim 1, wherein the axle further includes a middle section arranged between the right section and the left section; the middle section is installed with a mounting structure; the mount structure is formed by a belt, intermediate sleeve, a first mounting ring, a vertical shaft and a second mounting ring; the belt is of an inverted U shape wrapped onto the middle section and includes a fourth slot formed to penetrate therethrough along a long axis thereof, the intermediate sleeve includes a third hole configured to slide axially along the middle section in order to allow the intermediate sleeve to be limited inside the fourth slot; the first mounting ring includes a circular hole having a sealed circumference thereof; the first mounting ring includes a top edge having a connecting base formed thereon; the connecting base is provided for the vertical shaft to be pivotally attached thereto; the vertical shaft includes a second mounting ring arranged on top of the connecting base; the second mounting ring is installed onto the fourth slot of the belt.

16. The mounting type high-altitude movement fall arrester according to claim 2, wherein the axle further includes a middle section arranged between the right section and the left section; the middle section is installed with a mounting structure; the mount structure is formed by a belt, intermediate sleeve, a first mounting ring, a vertical shaft and a second mounting ring; the belt is of an inverted U shape wrapped onto the middle section and includes a fourth slot formed to penetrate therethrough along a long axis thereof; the intermediate sleeve includes a third hole configured to slide axially along the middle section in order to allow the intermediate sleeve to be limited inside the fourth slot; the first mounting ring includes a circular hole having a sealed circumference thereof; the first mounting ring includes a top edge having a connecting base formed thereon; the connecting base is provided for the vertical shaft to be pivotally attached thereto; the vertical shaft includes a second mounting ring arranged on top of the connecting base; the second mounting ring is installed onto the fourth slot of the belt.

17. The mounting type high-altitude movement fall arrester according to claim 1, wherein the locking member includes a bottom end having a third slot of an arched shape or a V shape formed thereon; the third slot is provided for matching with a top edge of the axle.

18. The mounting type high-altitude movement fall arrester according to claim 2, wherein the locking member includes a bottom end having a third slot of an arched shape or a V shape formed thereon; the third slot is provided for matching with a top edge of the axle.
